(19) United States
(12) Patent Application Publication
(10) Pub. No.: US 2026/0252338 A1
(43) Pub. Date: Aug. 27, 2026

(54) MANAGING OPERATING SYSTEM UPDATES AT AN INFORMATION HANDLING SYSTEM

(71) Applicant: Dell Products L.P., Round Rock, TX (US)

(72) Inventors: Ibrahim Sayyed, Georgetown, TX (US); Chris Edward Pepper, Leander, TX (US); Laxmi Lavanya Medicherla, Georgetown, TX (US); Krishnaveni Sistu, Leander, TX (US)

(21) Appl. No.: 19/065,546

(22) Filed: Feb. 27, 2025

(51) Int. Cl. G06F 8/65

(52) U.S. Cl. CPC G06F 8/65

(57) ABSTRACT

Managing operating system updates at an IHS, including: identifying an update to an OS of the IHS, the update including boot files to be stored at an ESP of a disk drive of the IHS; attempting to apply the update to the OS at the IHS, including attempting to write the boot files to the ESP; determining that the attempt to apply the update to the OS failed, in response: determining whether the ESP includes memory space for the boot files; determining that the ESP does not include memory space for the boot files, and in response: identifying, based on a data retention policy, non-critical files of the ESP; rebooting the IHS; after rebooting the IHS, removing the identified non-critical files from the ESP; after removing the identified non-critical files of the ESP, applying the update to the OS at the IHS, including writing the boot files to the ESP.

### BACKGROUND

### Field of the Disclosure

The disclosure relates generally to an information handling system, and in particular, managing operating system updates at an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Operating system updates are essential for maintaining the security and performance of your device. They often include patches for vulnerabilities that could be exploited by malware or hackers. Updates can also bring new features and improvements, enhancing the user experience. Regularly updating your operating system ensures compatibility with the latest software and hardware.

### SUMMARY

Innovative aspects of the subject matter described in this specification may be embodied in a method of managing operating system updates at an information handling system, including identifying an update to an operating system (OS) of the information handling system, the update including boot files to be stored at an Extensible Firmware Interface (EFI) system partition (ESP) of a disk drive of the information handling system; attempting to apply the update to the OS at the information handling system, including attempting to write the boot files to the ESP of the disk drive; determining that the attempt to apply the update to the OS failed, and in response: determining whether the ESP of the disk drive includes memory space for the boot files; determining that the ESP of the disk drive does not include memory space for the boot files, and in response: identifying, based on a data retention policy, non-critical files of the ESP of the disk drive; rebooting the information handling system; after rebooting the information handling system, removing the identified non-critical files from the ESP of the disk drive; and after removing the identified non-critical files of the ESP of the disk drive, applying, without user input, the update to the OS at the information handling system, including writing the boot files to the ESP of the disk drive of the information handling system.

Other embodiments of these aspects include corresponding systems, apparatus, and computer programs, configured to perform the actions of the methods, encoded on computer storage devices.

These and other embodiments may each optionally include one or more of the following features. For instance, determining that the attempt to apply the update to the OS failed includes determining that the attempt to write the boot files to the ESP of the disk drive failed. Removing the identified non-critical files of the ESP of the disk drive further includes removing the identified non-critical files of the ESP of the disk drive based on the data retention policy. Removing the identified non-critical files of the ESP of the disk drive based on the data retention policy further includes permanently deleting a subset of the non-critical files of the ESP of the disk drive. Removing the identified non-critical files of the ESP of the disk drive based on the data retention policy further includes transferring the non-critical files of the ESP of the disk drive to a cloud disk drive in communication with the information handling system over a network. Determining that the ESP of the disk drive does include memory space for the boot files, and in response: receiving telemetry data associated with the ESP of the disk drive, including receiving an error code; identifying, based on the error code, a remediation action at the information handling system; rebooting the information handling system; after rebooting the information handling system, performing the remediation action at the information handling system; after performing the remediation action at the information handling system, applying, without user input, the update to the OS at the information handling system, including writing the boot files to the ESP of the disk drive of the information handling system. The error code indicates an outdated BIOS firmware version, wherein performing the remediation act further includes: obtaining an updated version of the BIOS firmware over a network connection; and updating the BIOS firmware to the updated version. The error code indicates faulty secure boot settings firmware, wherein performing the remediation act further includes: obtaining updated secure boot settings firmware over a network connection; and updating the secure boot settings firmware to the updated secure boot settings firmware. Receiving the telemetry data further includes: accessing an Advanced Configuration and Power Interface (ACPI) table indicting the telemetry data associated with the BIOS of the information handling system. After performing the remediation action at the information handling system, updating the ACPI table to indicate the remediation action. After moving the identified non-critical files of the ESP of the disk drive, updating the ACPI table to indicate the removal of the non-critical files of the ESP of the disk drive.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing operating system updates.

FIG. 3 illustrates a method for managing operating system updates at the information handling system.

### DESCRIPTION OF PARTICULAR EMBODIMENT(S)

This disclosure discusses methods and systems for managing operating system updates of an information handling system. Specifically, this disclosure discusses a system and a method for managing operating system updates at an information handling system, including identifying an update to an operating system (OS) of the information handling system, the update including boot files to be stored at an Extensible Firmware Interface (EFI) system partition (ESP) of a disk drive of the information handling system; attempting to apply the update to the OS at the information handling system, including attempting to write the boot files to the ESP of the disk drive; determining that the attempt to apply the update to the OS failed, and in response: determining whether the ESP of the disk drive includes memory space for the boot files; determining that the ESP of the disk drive does not include memory space for the boot files, and in response: identifying, based on a data retention policy, non-critical files of the ESP of the disk drive; rebooting the information handling system; after rebooting the information handling system, removing the identified non-critical files from the ESP of the disk drive; and after removing the identified non-critical files of the ESP of the disk drive, applying, without user input, the update to the OS at the information handling system, including writing the boot files to the ESP of the disk drive of the information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

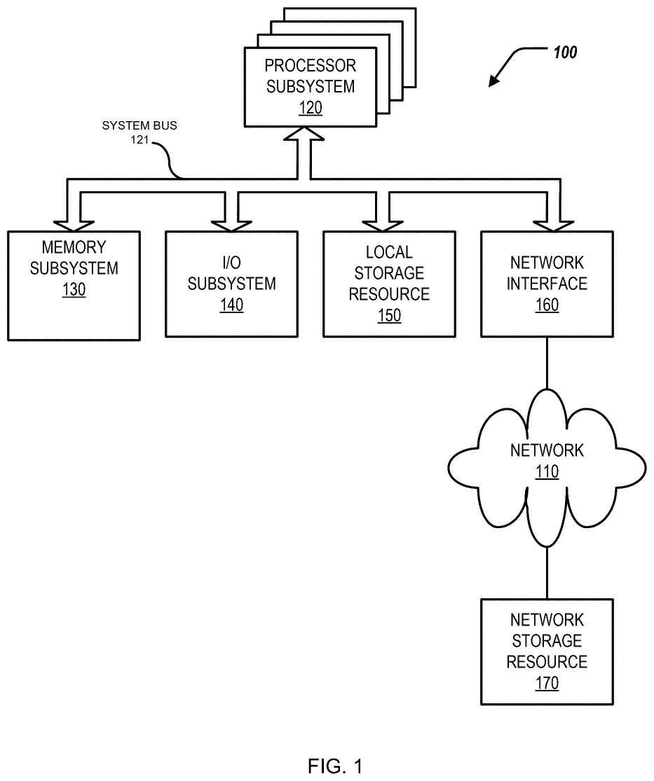

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

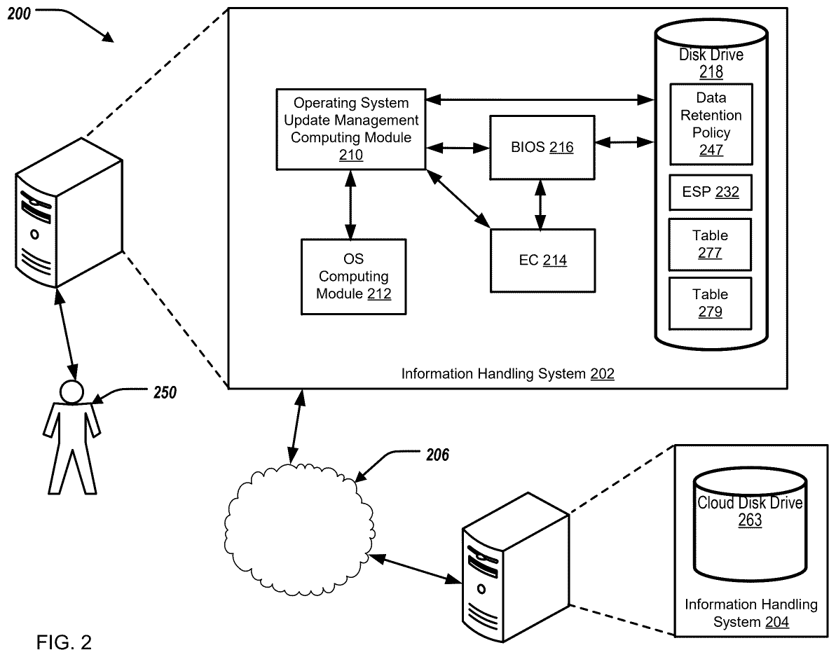

Turning to FIG. 2, FIG. 2 illustrates an environment 200 including an information handling system 202, an information handling system 204, and a network 206. The information handling system 202 can include an operating system update management computing module 210, an operating system (OS) computing module 212, an embedded controller (EC) 214, a basic input/output system (BIOS) 216, and a disk drive 218. In some examples, the information handling system 202 is similar to, or includes, the information handling system 100 of FIG. 1.

The information handling system 204 can include a cloud disk drive 263.

The information handling system 202 can be in communication with the information handling system 204 over the network 206.

The OS computing module 212 can be in communication with the operating system update management computing module 210. The operating system update management computing module 210 can be in communication with the EC 214, the BIOS 216, and the disk drive 218. The EC 214 can be in communication with the operating system update management computing module 210 and the BIOS 216. The BIOS 216 can be in communication with the operating system update management computing module 210, the EC 214, and the disk drive 218.

In some examples, the OS computing module 212 can include the OS of the information handling system 202, or be a representation of the OS of the information handling system 202. In some examples, the OS computing module 212 can indicate values of metrics or parameters of the OS of the information handling system 202. In some examples, the OS computing module 212 is the OS of the information handling system 202. In some examples, the OS computing module 212 can be in communication with the OS of the information handling system 202. In some examples, the OS computing module 212 can include data associated with the OS of the information handling system, including a version of the OS.

In some examples, the BIOS 216 can include the BIOS of the information handling system 202, or be a representation of the BIOS of the information handling system 202. In some examples, the BIOS 216 can indicate values of metrics or parameters of the BIOS of the information handling system 202. In some examples, the BIOS 216 is the BIOS of the information handling system 202. In some examples, the BIOS 216 can be in communication with the BIOS of the information handling system 202. In some examples, the BIOS 216 can include data associated with the BIOS of the information handling system, including a version of the OS.

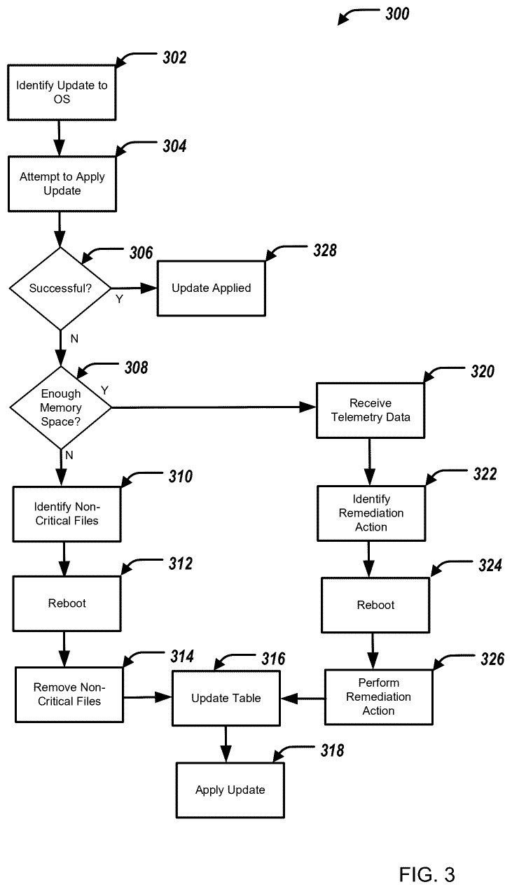

FIG. 3 illustrates a flowchart depicting selected elements of an embodiment of a method 300 for managing operating system updates at the information handling system. The method 300 may be performed by the information handling system 100, the information handling system 202, the OS computing module 212, the operating system update management computing module 210, the EC 214, and/or the BIOS 216, and with reference to FIGS. 1-2. It is noted that certain operations described in method 300 may be optional or may be rearranged in different embodiments.

The operating system update management computing module 210 identifies an update to the OS computing module 212, at 302. The update can include a security update to the OS computing module 212, a general update to the OS computing module 212, an IT maintenance update, or the like. The update can include boot files to be started at an Extensible Firmware Interface (EFI) system partition (ESP) 232 of the disk drive 218.

The operating system update management computing module 210 attempts to apply the update to the OS, at 304. Specifically, the operating system update management computing module 210 attempts to write the boot files of the update to the ESP 232 of the disk drive 218. The operating system update management computing module 210 can attempt to write the boot files of the update to the ESP 232 utilizing the EC 214 and the BIOS 216. The attempt to write the boot files of the update to the ESP 232 can include accessing the ESP 232, and attempting to write the boot files of the update to the ESP 232, including attempting to overwrite existing files of the ESP 232. The attempt to write the boot files of the update to the ESP 232 can include receiving the update to the OS, and accessing the ESP 232 and sending data to the ESP 232 (through the EC 214 and the BIOS 216). The boot files of the update can include a bootloader and boot configuration data (BCD).

The operating system update management computing module 210 determines whether the attempt to apply the update to the OS failed, at 306. That is, the operating system update management computing module 210 can determine whether the attempt to write the boot files to the ESP 232 failed. In some examples, the operating system update management computing module 210 can determine whether the access of the ESP 232, and attempt to write the boot files of the update to the ESP 232 failed, including determining whether the attempt to overwrite existing files of the ESP 232 failed. In some examples, the operating system update management computing module 210 can determine that receiving the update to the OS, and whether accessing the ESP 232 and sending data to the ESP 232 (through the EC 214 and the BIOS 216) has failed.

In some examples, the operating system update management computing module 210 determines that the attempt to apply the update to the OS failed (at 306), and in response, determines whether the ESP 232 includes memory space for the boot files of the OS update, at 308. Specifically, the operating system update management computing module 210 determines that the attempt to write the boot files to the ESP 232 failed (at 306), and in response, determines whether the ESP 232 includes memory space for the boot files of the OS update, at 308. In some examples, the operating system update management computing module 210 can provide instructions to the BIOS 216 to determine whether the ESP 232 includes memory space for the boot files of the OS update. The BIOS 216 can scan the ESP 232 to identify diagnostics of the ESP 232 and telemetry files, including a storage saturation of the ESP 232. For example, the ESP 232 can be 100 Megabytes (MBs), and OS files, recovery files, firmware images, previous firmware image copies, and the like can utilize an entirety (or near entirety) of the ESP 232.

In some examples, the operating system update management computing module 210 determines that the ESP 232 does not include memory space for the boot files of the OS update (at 308), and in response, identifies, based on a data retention policy 247, non-critical files of the ESP 232, at 310. That is, the operating system update management computing module 210 determines that the ESP 232 does not include adequate memory space for the boot files of the OS update that is not previously allocated to other resources. In other words, the operating system update management computing module 210 determines that there is not unused/free memory space in the ESP 232 for storing of the boot files of the OS update. That is, the memory space of the ESP 232 is occupied with other files/resources, and the ESP 232 is considered “saturated.”

The operating system update management computing module 210 can identify the non-critical files of the ESP 232 in response to the ESP 232 not including memory space for the boot files of the OS update. In some examples, the operating system update management computing module 210 utilizes the BIOS 216 to identify the non-critical files of the ESP 232. The non-critical files can include files that are “unnecessary” files/data and/or files/data related to inefficient previous updates of the OS. In some examples, the operating system update management computing module 210 and/or the BIOS 216 can identify the non-critical files of the ESP 232 based on the data retention policy 247. That is, the data retention policy 247 can indicate specific files/logs/data that are to be retained (critical), specific files/logs/data that are expendable (non-critical), types of files/logs/data that are to be retained (critical), types of files that are expendable (non-critical), specific files/logs/data that are stale (non-critical), and types of files that are stale (non-critical) and the like.

In some cases, the BIOS 216 identifies telemetry files of the ESP 232 (when attempting to apply the update to the OS), including receiving an error code. The error code can indicate the saturation of the ESP 232. In some cases, the operating system update management computing module 210 and/or the BIOS 216 can determine, in response to the error code indicating the saturation of the ESP 232, a root cause of such storage saturation of the ESP 232. For example, the ESP 232 can include an accumulation of “unnecessary” files and inefficient update processes.

The information handling system 202 is rebooted, at 312. The information handling system 202 can reboot in response to a signal or command from the operating system update management computing module 210. In some examples, the information handling system 202 is rebooted after the non-critical files are identified from the ESP 232.

The operating system update management computing module 210 removes the identified non-critical files from the ESP 232, at 314. In some examples, the operating system update management computing module 210 utilizes the BIOS 216 to facilitate removing the non-critical files from the ESP 232. In some examples, the non-critical files are removed from the ESP 232 after rebooting the information handling system 202. That is, the non-critical files are removed from the ESP 232 to make memory room or memory space for the boot files of the OS update.

In some examples, the operating system update management computing module 210 removes the identified non-critical files from the ESP 232 based on the data retention policy 247, at 314. That is, as the data retention policy 247 can indicate specific files/logs/data that are to be retained (critical), specific files/logs/data that are expendable (non-critical), types of files/logs/data that are to be retained (critical), types of files that are expendable (non-critical), specific files/logs/data that are stale (non-critical), and types of files that are stale (non-critical) and the like, and the operating system update management computing module 210 removes the identified non-critical files from the ESP 232 based on such.

In some examples, the operating system update management computing module 210 removes the identified non-critical files from the ESP 232 by permanently deleting a subset of the non-critical files of the ESP 232. That is, the operating system update management computing module 210 (e.g., through the BIOS 216) can permanently delete a subset of the non-critical files, or an entirety of the non-critical files. Deletion of the non-critical files can include removal of the non-critical files from the ESP 232 and the disk drive 218.

In some examples, the operating system update management computing module 210 removes the identified non-critical files from the ESP 232 by transferring the non-critical files of the ESP 232 to the cloud disk drive 263 of the information handling system 204. In other words, the operating system update management computing module 210 moves the non-critical files from the ESP 232 to the cloud disk drive 263 over the network 206. The information handling system 202 can exercise a network function (at a later time) that can access these non-critical files if needed for later computing functionality.

The operating system update management computing module 210 can update a table 277 stored at the disk drive 218, at 316. Specifically, the operating system update management computing module 210 updates the table 277 to indicate the removal of the identified non-critical files from the ESP 232. In some examples, the table 277 can be updated to indicate the specific non-critical files that were removed, whether the files were deleted and/or transferred to the cloud disk drive 263, and other metadata associated with the removal of the non-critical files. In some examples, the table 277 is an Advanced Configuration and Power Interface (ACPI) table.

The operating system update management computing module 210 applies the update to the OS, at 318. Specifically, the operating system update management computing module 210 writes the boot files to the ESP 232 (e.g., through the BIOS 216). The operating system update management computing module 210 applies the update to the OS, including writing the boot files to the ESP 232, after removing the identified non-critical files of the ESP 232. In other words, by removing the non-critical files from the ESP 232, the ESP 232 includes memory bandwidth/space for inclusion/storage of the boot files of the update to the OS.

Furthermore, the operating system update management computing module 210 applies the update to the OS, including writing the boot files to the ESP 232, without user input/intervention. That is, the operating system update management computing module 210 applies the update to the OS, including writing the boot files to the ESP 232, independent of user action by a user 250 of the information handling system. That is, the operating system update management computing module 210 applies the update to the OS, including writing the boot files to the ESP 232, automatically in response to identifying the update to the OS and removing the identified non-critical files of the ESP 232 and without user interaction/input. The operating system update management computing module 210 can perform the remediation action (or remediation actions) to enable updating of the OS by improving performance capabilities of the information handling system 202. That is, performing the remediation action(s) to the information handling system 202 by the operating system update management computing module 210 improves the performance capabilities of the information handling system 202 such that the functionality and the operability of the computing features of the information handling system 202 is improved by updating the OS of the information handling system 202. In some examples, the operating system update management computing module 210 can perform the remediation action (or remediation actions) to improve the performance capabilities of the information handling system 202 without user action/input by the user 250 (independent of user action/input by the user 250).

In some implementations, the operating system update management computing module 210 determines that the ESP 232 does include memory space for the boot files of the OS update (at 308), and in response, receives telemetry data associated with the ESP 232, at 320. In some cases, the BIOS 216 identifies telemetry files of the ESP 232 (when attempting to apply the update to the OS), including receiving an error code. The BIOS 216 can provide data indicating the error code to the operating system update management computing module 210. In some examples, the operating system update management computing module 210 updates the table 277 to indicate the received telemetry data, including the received error code.

The operating system update management computing module 210 can identify, based on the error code, a remediation action, at 322. That is, the operating system update management computing module 210 can identify a remediation action for the error code based on a table 279 stored by the disk drive 218. The table 279 can indicate, for each error code of multiple error codes, a corresponding remediation action. In some examples, the table 279 is an Advanced Configuration and Power Interface (ACPI) table. In some examples, the error code can indicate a failing hard drive or memory issues of the information handling system 202 that can prevent the OS update from being installed correctly. In some examples, the error code can indicate an outdated BIOS firmware version as the OS update may require a specific BIOS firmware version for the OS update to be installed correctly. In some examples, the error code can indicate incorrect BIOS settings (such as hard drive configurations after reboot, boot order, secure boot settings) for the OS update to be installed correctly. In some examples, the error code can indicate incorrect BIOS secure boot settings (such as trusted and signed bootloaders) for the OS update to be installed correctly.

The information handling system 202 is rebooted, at 324. The information handling system 202 can reboot in response to a signal or command from the operating system update management computing module 210.

The operating system update management computing module 210 can perform the remediation action at the information handling system 202, at 326. In some examples, the operating system update management computing module 210 performs the remediation action at the information handling system 202 after rebooting the information handling system 202. For example, the operating system update management computing module 210 can determine that the error code indicates an outdated BIOS firmware version. The operating system update management computing module 210 can perform the remediation action of obtaining an updated version of the BIOS firmware. The operating system update management computing module 210 can obtain the updated version of the BIOS firmware over a network (such as network 206). The operating system update management computing module 210 can update the BIOS firmware to the updated version.

For example, the operating system update management computing module 210 can determine that the error code indicates faulty secure boot settings firmware. The operating system update management computing module 210 can perform the remediation action of obtaining updated secure boot settings firmware. The operating system update management computing module 210 can obtain the updated secure boot settings firmware over a network (such as network 206). The operating system update management computing module 210 can update the secure boot settings firmware to the updated secure boot settings firmware.

For example, the operating system update management computing module 210 can determine that the error code indicates an outdated disk drive firmware version. The operating system update management computing module 210 can perform the remediation action of obtaining an updated version of the disk drive firmware. The operating system update management computing module 210 can obtain the updated version of the disk drive firmware over a network (such as network 206). The operating system update management computing module 210 can update the disk drive firmware to the updated version.

The operating system update management computing module 210 can update the table 277 stored at the disk drive 218, at 316. Specifically, the operating system update management computing module 210 updates the table 277 to indicate the removal of the identified non-critical files from the ESP 232. In some examples, the table 277 can be updated to indicate the specific non-critical files that were removed, whether the files were deleted and/or transferred to the cloud disk drive 263, and other metadata associated with the removal of the non-critical files.

In some cases, the operating system update management computing module 210 updates the table 277 to indicate the remediation action taken. That is, the operating system update management computing module 210 updates the table 277 to indicate the error code and the remediation action taken, and whether the installation of the OS update and the boot files was successful or not.

The operating system update management computing module 210 applies the update to the OS, at 318. Specifically, the operating system update management computing module 210 writes the boot files to the ESP 232 (e.g., through the BIOS 216). The operating system update management computing module 210 applies the update to the OS, including writing the boot files to the ESP 232, after performing the remediation action. In other words, by performing the remediation action, the information handling system 202 is able to have the update to the OS applied, including remediation actions at the BIOS or other computing hardware of the information handling system 202.

Furthermore, the operating system update management computing module 210 applies the update to the OS, including writing the boot files to the ESP 232, without user input/intervention. That is, the operating system update management computing module 210 applies the update to the OS, including writing the boot files to the ESP 232, independent of user action by a user 250 of the information handling system. That is, the operating system update management computing module 210 applies the update to the OS, including writing the boot files to the ESP 232, automatically in response to identifying the update to the OS and performing the remediation action at the information handling system 202 and without user interaction/input. The operating system update management computing module 210 can perform the remediation action (or remediation actions) to enable updating of the OS by improving performance capabilities of the information handling system 202. That is, performing the remediation action(s) to the information handling system 202 by the operating system update management computing module 210 improves the performance capabilities of the information handling system 202 such that the functionality and the operability of the computing features of the information handling system 202 is improved by updating the OS of the information handling system 202. In some examples, the operating system update management computing module 210 can perform the remediation action (or remediation actions) to improve the performance capabilities of the information handling system 202 without user action/input by the user 250 (independent of user action/input by the user 250).

In some examples, the operating system update management computing module 210 determines that the attempt to apply the update to the OS was successful (at 306), and in response, the OS is updated, at 328. In some cases, the operating system update management computing module 210 updates the table 277 to indicate that the installation of the OS update and the boot files was successful.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing operating system updates at an information handling system, including:
identifying an update to an operating system (OS) of the information handling system, the update including boot files to be stored at an Extensible Firmware Interface (EFI) system partition (ESP) of a disk drive of the information handling system;
attempting to apply the update to the OS at the information handling system, including attempting to write the boot files to the ESP of the disk drive;
determining that the attempt to apply the update to the OS failed, and in response:
determining whether the ESP of the disk drive includes memory space for the boot files;
determining that the ESP of the disk drive does not include memory space for the boot files, and in response:
identifying, based on a data retention policy, non-critical files of the ESP of the disk drive;
rebooting the information handling system;
after rebooting the information handling system, removing the identified non-critical files from the ESP of the disk drive; and
after removing the identified non-critical files of the ESP of the disk drive, applying, without user input, the update to the OS at the information handling system, including writing the boot files to the ESP of the disk drive of the information handling system.

2. The computer-implemented method of claim 1, wherein determining that the attempt to apply the update to the OS failed includes determining that the attempt to write the boot files to the ESP of the disk drive failed.

3. The computer-implemented method of claim 1, wherein removing the identified non-critical files of the ESP of the disk drive further includes removing the identified non-critical files of the ESP of the disk drive based on the data retention policy.

4. The computer-implemented method of claim 3, wherein removing the identified non-critical files of the ESP of the disk drive based on the data retention policy further includes permanently deleting a subset of the non-critical files of the ESP of the disk drive.

5. The computer-implemented method of claim 3, wherein removing the identified non-critical files of the ESP of the disk drive based on the data retention policy further includes transferring the non-critical files of the ESP of the disk drive to a cloud disk drive in communication with the information handling system over a network.

6. The computer-implemented method of claim 1, further including:
determining that the ESP of the disk drive does include memory space for the boot files, and in response:
receiving telemetry data associated with the ESP of the disk drive, including receiving an error code;
identifying, based on the error code, a remediation action at the information handling system;
rebooting the information handling system;
after rebooting the information handling system, performing the remediation action at the information handling system;
after performing the remediation action at the information handling system, applying, without user input, the update to the OS at the information handling system, including writing the boot files to the ESP of the disk drive of the information handling system.

7. The computer-implemented method of claim 6,
wherein the error code indicates an outdated BIOS firmware version,
wherein performing the remediation act further includes:
obtaining an updated version of the BIOS firmware over a network connection; and
updating the BIOS firmware to the updated version.

8. The computer-implemented method of claim 7,
wherein the error code indicates faulty secure boot settings firmware,
wherein performing the remediation act further includes:
obtaining updated secure boot settings firmware over a network connection; and
updating the secure boot settings firmware to the updated secure boot settings firmware.

9. The computer-implemented method of claim 7, wherein receiving the telemetry data further includes:
accessing an Advanced Configuration and Power Interface (ACPI) table indicting the telemetry data associated with the BIOS of the information handling system.

10. The computer-implemented method of claim 9, after performing the remediation action at the information handling system, updating the ACPI table to indicate the remediation action.

11. The computer-implemented method of claim 9, after moving the identified non-critical files of the ESP of the disk drive, updating the ACPI table to indicate the removal of the non-critical files of the ESP of the disk drive.

12. An information handling system comprising a processor having access to memory media storing instructions executable by the processor to perform operations, comprising:
identifying an update to an operating system (OS) of the information handling system, the update including boot files to be stored at an Extensible Firmware Interface (EFI) system partition (ESP) of a disk drive of the information handling system;
attempting to apply the update to the OS at the information handling system, including attempting to write the boot files to the ESP of the disk drive;
determining that the attempt to apply the update to the OS failed, and in response:
determining whether the ESP of the disk drive includes memory space for the boot files;
determining that the ESP of the disk drive does not include memory space for the boot files, and in response:
identifying, based on a data retention policy, non-critical files of the ESP of the disk drive;
rebooting the information handling system;
after rebooting the information handling system, removing the identified non-critical files from the ESP of the disk drive; and
after removing the identified non-critical files of the ESP of the disk drive, applying, without user input, the update to the OS at the information handling system, including writing the boot files to the ESP of the disk drive of the information handling system.

13. The information handling system of claim 12, wherein determining that the attempt to apply the update to the OS failed includes determining that the attempt to write the boot files to the ESP of the disk drive failed.

14. The information handling system of claim 12, wherein removing the identified non-critical files of the ESP of the disk drive further includes removing the identified non-critical files of the ESP of the disk drive based on the data retention policy.

15. The information handling system of claim 14, wherein removing the identified non-critical files of the ESP of the disk drive based on the data retention policy further includes permanently deleting a subset of the non-critical files of the ESP of the disk drive.

16. The information handling system of claim 14, wherein removing the identified non-critical files of the ESP of the disk drive based on the data retention policy further includes transferring the non-critical files of the ESP of the disk drive to a cloud disk drive in communication with the information handling system over a network.

17. The information handling system of claim 12, the operations further including:
determining that the ESP of the disk drive does include memory space for the boot files, and in response:
receiving telemetry data associated with the ESP of the disk drive, including receiving an error code;
identifying, based on the error code, a remediation action at the information handling system;
rebooting the information handling system;
after rebooting the information handling system, performing the remediation action at the information handling system;
after performing the remediation action at the information handling system, applying, without user input, the update to the OS at the information handling system, including writing the boot files to the ESP of the disk drive of the information handling system.

18. The information handling system of claim 17,
wherein the error code indicates an outdated BIOS firmware version,
wherein performing the remediation act further includes:
obtaining an updated version of the BIOS firmware over a network connection; and
updating the BIOS firmware to the updated version.

19. The information handling system of claim 18,
wherein the error code indicates faulty secure boot settings firmware,
wherein performing the remediation act further includes:
obtaining updated secure boot settings firmware over a network connection; and
updating the secure boot settings firmware to the updated secure boot settings firmware.

20. A non-transitory computer-readable medium storing software comprising instructions executable by one or more computers which, upon such execution, cause the one or more computers to perform operations comprising:
identifying an update to an operating system (OS) of the information handling system, the update including boot files to be stored at an Extensible Firmware Interface (EFI) system partition (ESP) of a disk drive of the information handling system;
attempting to apply the update to the OS at the information handling system, including attempting to write the boot files to the ESP of the disk drive;
determining that the attempt to apply the update to the OS failed, and in response:
determining whether the ESP of the disk drive includes memory space for the boot files;
determining that the ESP of the disk drive does not include memory space for the boot files, and in response:
identifying, based on a data retention policy, non-critical files of the ESP of the disk drive;
rebooting the information handling system;
after rebooting the information handling system, removing the identified non-critical files from the ESP of the disk drive; and
after removing the identified non-critical files of the ESP of the disk drive, applying, without user input, the update to the OS at the information handling system, including writing the boot files to the ESP of the disk drive of the information handling system.
